(19) United States
(12) Patent Application Publication
(10) Pub. No.: US 2006/0075092 A1
(43) Pub. Date: Apr. 6, 2006

(54) System and method for determining the status of users and devices from access log information

(75) Inventor: Kazuaki Kidokoro, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/958,332

(22) Filed: Oct. 6, 2004

(51) Int. Cl. G06F 15/173

(52) U.S. Cl. 709/224

(57) ABSTRACT

A system and method for determining status of one or more devices in a network includes accessing access log information for one or more devices on the network, the access log information including information about one or more events occurring at a device. A set of rules including one or more rules is applied to the access log information. The status of the one or more devices is determined based on the application of the set of rules to the access log information.

### FIELD OF THE INVENTION

The present invention relates generally to network processing and, more particularly, to a system and method for determining the status of users and devices in a network using access log information.

### BACKGROUND OF THE INVENTION

In a network communication system, users or network administrators can use SNMP (simple network maintenance protocol) to manage devices and determine device status for some devices in the network. For example, SNMP can ask devices for their status or can request devices to change their status, such as to shutdown or to initialize. SNMP gathers network data from a single type of MIB (management information base). As a result, SNMP management is available only when both the target device and the client computer support the same protocol, which typically requires customized management efforts at the client computer and takes significant user time to develop.

Moreover, while SNMP is commonly used for the maintenance of computers and printers, it is not designed to manage other types of devices, such as faxes and MFPs (multi-function peripherals). SNMP also does not show the status of users in the network communication system.

### SUMMARY OF THE INVENTION

Briefly, in one aspect of the invention, a system and method for determining status of one or more devices in a network includes accessing access log information for one or more devices on the network, the access log information including information about one or more events occurring at a device. A set of rules including one or more rules is applied to the access log information. The status of the one or more devices is determined based on the application of the set of rules to the access log information.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a network system consistent with the present invention.

FIG. 2 is a flow diagram of a status determination process consistent with the present invention.

FIG. 3A is an example of an access log for a client computer consistent with the present invention.

FIG. 3B is an example of a status table for a client computer consistent with the present invention.

FIG. 4A is an example of an access log for a printer consistent with the present invention.

FIG. 4B is an example of a status table for a printer consistent with the present invention.

FIG. 5A is an example of an access log for a network system consistent with the present invention.

FIG. 5B is an example of a status table for a network system consistent with the present invention.

### DETAILED DESCRIPTION OF PREFERRED EMBODIMENTS OF THE INVENTIONS

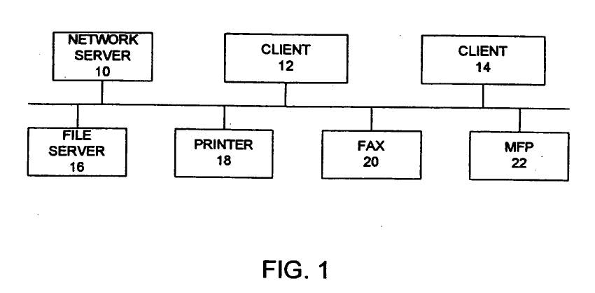

FIG. 1 is a block diagram of a network system consistent with the present invention. As shown in FIG. 1, the network system includes a network server 10, users 12 and 14, a file server 16, a printer 18, a fax 20 and a multi-function peripheral (MFP) 22. Each of these devices is connected through a network, such as a local area network (LAN), the Internet, or any other known system enabling the devices to communicate with each other.

The network server 10 can be configured to operate, for example, as a LAN server or a web server. The network server 10 can include a processor, such as a CPU, a memory, which may include RAM, ROM and a hard disk drive, and a communication interface scheme to enable the network server 10 to communicate with other devices in the network system. Further, the network server 10 can include programming (stored on any medium) to enable it to perform various networking functions, including managing and monitoring other devices in the network system.

The clients 12 and 14 may be any of a PC, laptop computer, cell phone, PDA or other processing device that can be connected to the network system through a communication interface, such as a LAN card or modem. Clients 12 and 14 may have one or more different users that can work or operate the particular client. The clients 12 and 14 can perform functions or create jobs to be performed by other devices in the network system in response to inputs or instructions from a user at the client. For example, a first user can request through client 12 that a document be printed on printer 18, and a second user can request through client 14 that a document be faxed by fax 20 or that a document be opened from file server 16. Although only two clients 12 and 14 are shown in FIG. 1, it should be understood that there can be more or fewer clients than those shown.

The file server 16 maintains documents or files that can be accessed by the other devices in the network system. The file server 16 can also include the functionality of a mail server, which includes creating, sending, receiving and storing e-mail messages for users of the network system. Alternatively, the mail server functionality can be included within the network server 12, or as a server independent of the file server 16 and the network server 12. Although shown separately from the network server 12, the functionality of the file server 16 and the network server 12 can be implemented in the same processing device. Like the network server 12, the file server 16 can include a processor, such as a CPU, a memory, which may include RAM, ROM and a hard disk drive, and a communication interface scheme to enable the file server 16 to communicate with other devices in the network system. The file server 16 can also include programming to enable it to perform file management functions.

The printer 18 is a device that is capable of printing a hardcopy version of a document or file. The fax 20 is a device that is capable of sending or receiving a fax job. The MFP 22 is a device that is capable of performing a plurality of functions, such as printing, copying, faxing, scanning and acting as a file server. The MFP 22 typically includes at least two of these functions. Although the network system is shown with one printer 18, one fax 20, and one MFP 22, the network system may have just one of these types of devices or may have a plurality of one or more of these types of devices or any other type of device that may be connected to a network.

Each device in the network system, including the clients 12 and 14, the file server 16, the printer 18, the fax 20, and the MFP 22, is preferably configured to maintain an access log. The access log preferably includes information about events, such as functions or jobs, that are performed by the device. Depending upon the type of device, the access log may be referred to as the job log or the access history. For example, the printer 18 typically maintains a job log, and the file server 16 (and the mail server) typically maintain an access history. The access log covers job logs, access histories, and any other configuration capable of recording information about the functions and/or jobs performed by the device.

The access log can maintain various categories of information for each event occurring at the device. The categories include, for example, the time that the event occurs, which may include the beginning and the ending, the device performing the event, the device requesting that the event be performed, the user requesting that the event be performed, the document or file involved in the event, and the result of the event. These categories are not exclusive as other categories may also be recorded for each event occurring on a device. Further, each device may record information for only a select group of these categories. The particular categories that are recorded in the access log for a particular device generally depend on the type of device and the software configuration of the device, which is typically set by the manufacturer of the device. Through the present embodiment of the invention, it is possible to use the access logs from the devices in the network system and determine the status of the devices, as well as the status of users operating in the network system.

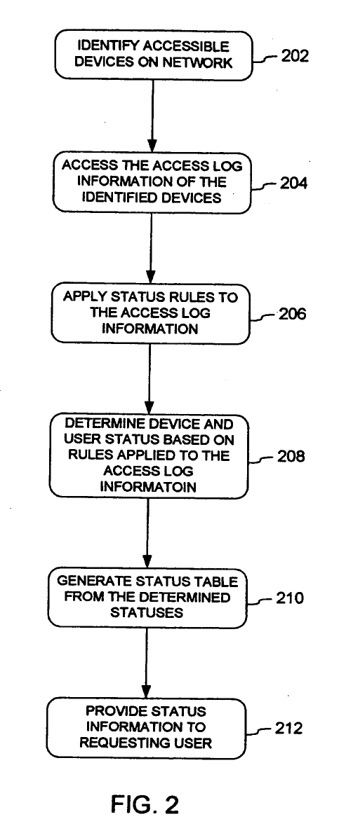

FIG. 2 is a flow diagram of a status determination process consistent with the present invention. As shown in FIG. 2, the first step is identifying which devices in the network system are accessible (step 202). The devices identified are preferably ones maintaining an access log, such as the clients 12 and 14, file server 16, printer 18, fax 20, and MFP 22. The identification can be performed, for example, by network server 10 or other processing device in the network system.

For each identified device, the access log is accessed (step 204). The manner in which the access log is accessed depends on how the status for the devices and users is determined. The status determination can be done through a combination of individual analyses of each device in combination with a centralized analysis. Alternatively, the status determination can be done through a centralized analysis only. When the combined analysis is done, the device itself accesses the access log. When the analysis is done centrally only, then the network server 10 or other networked processing device can access the access log. When the network server 10 does the accessing, it may include downloading the access log from each identified device to the network server 10.

When the network system includes different types of identified devices, it is likely that the format of the access log for at least some of the devices will be different. To address this possibility, when accessing the access log of each identified device, the network server preferably determines the format of the access log. The format of the access log may be determined from the device type. Alternatively, information about the format of the access log may be included as part of the access log itself. Another approach it to, as part of accessing the access log, convert the access log to a common or uniform format before being downloaded to the network server 10. The reformatting can be done at the devices, or the network server 10 could also take the necessary information from the devices and convert it into the necessary format.

The access logs provided to the network server 10 from the identified devices can be merged into a network-wide access log. This network-wide access log can identify events common to more than one device and merge the information of those events. For example, the client 12 may request that a document be printed on printer 18. The access log for the client 12 may identify the time of the print request, the printer to which the request was made, the document being printed, and the result of the request. The access log for the printer 18 may similarly identify the time of the request, the document being printed and the result, but it may also identify the client making the request and the user of that client making the request. Accordingly, the network wide access log would record the time, client, user, printer, document and result for this event.

Having accessed the access logs of the identified devices in the network system, a set of status rules is applied to the access logs (step 206). The status rules are a group of tests or rules applied to the information in the access log to indicate the status of the devices and users in the network system. Factors included in the status rules comprise, for example, the most recent event involving the device or user, the time of the most recent event relative to the current time, the result of the event, and the number of events occurring in a predetermined period from the current time.

The rules can be stored at the network server 10 and applied by the network server 10 against the access logs obtained from the devices in the network system. Alternatively, each device can store its own set of the status rules and apply them to the respective access logs for that device. It is also possible for the devices to access the status rules stored in a location separate from the device, such as in the network server 10, and to apply the accessed status rules to their respective access logs.

The status rules may take any of widely varying formats, and depend on the particular desired implementation of a network. For example, using the access log of a device such as the printer 18, the rules may ascertain the status of a user based on user access to the printer 18, as well as the status of the printer 18 itself. A user may be active if the user accessed the printer 18 within a certain period, such as within 30 minutes from the current time, whereas the user may be deemed inactive if the user does not access the printer 18 for more than one hour. For the in-between period, the status of the user can be identified as “may be active.” Another possibility is that the printer is currently inoperative for which the status may be “down.” For the status of the printer 18, the status rule may identify the status as being the same as the last executed job result of the printer 18.

For other types of devices, such as clients 12 and 14, the status rules may identify the status of the clients 12 and 14 as active if they are accessed within 30 minutes from the current time or as being the same as the result of last sent job result to another device. The status rule may also identify the status of the clients 12 and 14 as unknown or inactive if they are not accessed for more than one hour. Such status rules can be useful when the clients 12 and 14 are running some background programs that access network devices without user interaction, such as automatic access to web servers for gathering updated pages.

Where the network server 10 gathers the access logs from the various network devices, the status rules may identify a device as active if it has been accessed within 30 minutes from the current time. Other status rules may be that a device is busy if it has received more than ten jobs within the last ten minutes, or that the status of a device matches the result of last job executed by the device. For users, the status rule may be that a user is active if the user sent a job to a device within the last 30 minutes and, more specifically, that the status is “at desk” if a job has been sent to any device within the last ten minutes. If the network devices include location information, which is typically part of the device information, the status rules can also be applied to identify the location of a user. For example, it is possible to identify a user as located at a particular location based on the most recent activity in the access log information and the location information for the network device corresponding to the most recent activity. The given examples of status rules are exemplary only. It should be understood that other status rules for determining the status of devices and users in the network are also possible.

Based on the application of the status rules to the access log information from the devices in the network system, the status of the devices and the users can be determined (step 208). The status for a device may be determined to be, for example, active, idle, busy, unknown, or error. If the status is error, it is also possible to identify the cause of the error, such as “no paper” for the printer 18. It is also possible for the status of the device to be active in combination with another status, such as idle or busy. For the user, the status may be any of active, at desk, “may be active” (or inactive), inactive or unknown. Depending upon the information from the access logs and the design of the status rules, other status definitions are also possible.

Based on the determination of the status for the devices and users, a status table can be generated (step 210). The status table can list each of the devices and users present in the network system or a select grouping of them. For each device or user in the table, a corresponding status is provided. The status table can have further information items, such as the time at which the status was updated, the time at which the status of a particular device or user attained the identified status, and the job or function most recently performed by or requested by a device or user. The status table can be stored, for example, in the respective devices or in the network server 10.

The application of the status rules to the access log information, the determination of the status of the devices and users based on the access log information, and the generation of the status table can be performed at regular intervals, such as every ten minutes. They can also be performed each time a job or function is performed or when a job or function is requested by a device or user. It is also possible to perform these functions in response to a specific request by a user or a network administrator. Once the status table is generated, it is no longer necessary to store the access log information downloaded from the devices. Moreover, in subsequent accesses to the access logs, it may be possible to download only the information that has been created since the previous download, and update the status table based solely on the new information. Furthermore, the access log at each device can be maintained just long enough to meet the longest time-based status rule, such as just over one hour.

In addition to determining the status of the devices and users and generating a status table based on those determinations, the status information can be provided to a requesting user (step 212). The request can be from a user or a network administrator at one of the clients 12 and 14. It is also possible for the request to be sent remotely to the network system. The status information provided in response to the request can be sent as a message to the requesting user, such as an e-mail message or a pop-up window, which can be displayed on the clients 12 and 14 or other device through which the status request is made.

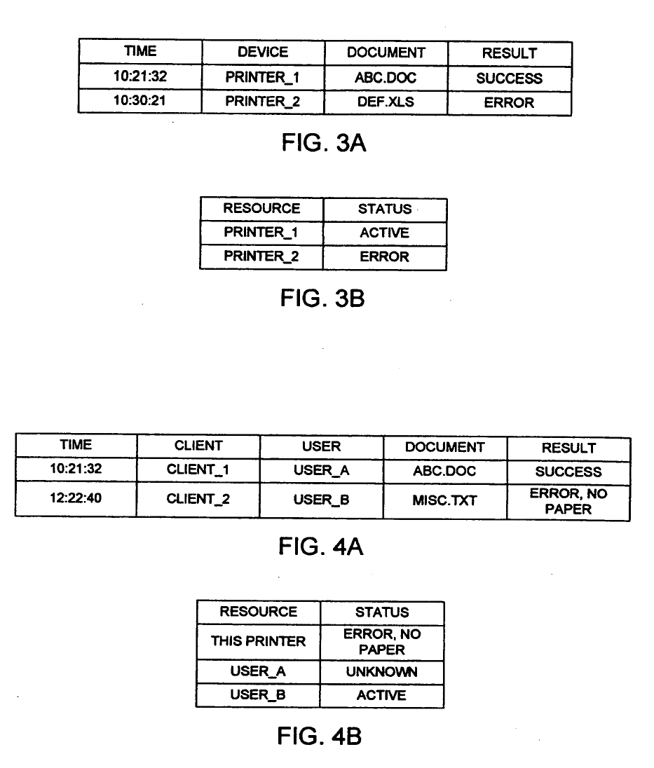

To further explain the process of FIG. 2, the following description will provide examples of access logs and status tables for exemplary devices in a network system. FIG. 3A is an example of an access log for a client computer consistent with the present invention. As shown in FIG. 3A, the access log includes four categories: TIME, DEVICE, DOCUMENT, and RESULT. For the client computer, such as clients 12 and 14, the TIME corresponds to the time at which a job or function is created by the client computer. The DEVICE corresponds to the device involved in the processing or completion of the job or function. In this case, a job at 10:21:32 was sent to PRINTER_1, and another job at 10:30:21 was sent to PRINTER_2. The third item, DOCUMENT, corresponds to the document or file that is the subject of the job. Finally, the RESULT corresponds to whether the processing of the job or function was completed successfully or whether an error occurred. As described previously, the access log may include other items or categories, such as the type of job or function (e.g., print a document, open/close a document, fax a document, etc.) and the user creating the job or function.

As also described previously, the status rules can be applied to the access log by the device itself or by a centralized device, such as the network server 10. FIG. 3B is an example of a status table for a client computer consistent with the present invention where the client computer itself applies the status rules to the access log. As shown in FIG. 3A, the only devices or users identified in the access log are PRINTER_1 and PRINTER_2, the status table can identify the status of these two devices. In this case, the status rule that is applied defines the status as matching the result of the most recently performed job or function. As a result, the status table in FIG. 3B identifies the status of PRINTER_1 as ACTIVE and PRINTER_2 as ERROR. Depending upon the current time relative to the time of the job, the status of PRINTER_1 could be further defined by the application of the status rules. For example, another status rule may define a device as idle if it has not performed a job within a certain period, such as an hour. In this case, if the current time is 12:30:00, then the PRINTER_1 would be IDLE as well as ACTIVE as the most recently performed job was more than one hour from the current time. Although not shown, it is also possible that the client computer can apply the status rules to define its own status, such as UNKNOWN, INACTIVE or MAY BE INACTIVE since the most recent activity is more than one hour from the current time.

FIG. 4A is an example of an access log for a printer consistent with the present invention. The access log for the printer, such as printer 18, includes the same categories as the client computer access log except it does not include DEVICE, but does include CLIENT and USER. The CLIENT category corresponds to the client computer, such as clients 12 and 14, that submitted the job to the printer. USER corresponds to the user at the client computer who submitted the job to the printer.

FIG. 4B is an example of a status table for a printer consistent with the present invention where the printer itself applies the status rules. As shown in FIG. 4B, the status is determined for the printer itself, USER_A and USER_B. In this example, the status for the printer itself is ERROR, NO PAPER, the status for USER_A is UNKNOWN, and the status for USER_B is ACTIVE. For the printer 18, the applicable status rule matches the result of the most recent job, which in this case is being in error because there is no paper. For the users, the applicable status rules are time-based based on the time of their most recent activity. If the current time is 12:30:00, then it would have been more than two hours since USER_A was active, which would result in a status of INACTIVE. For USER_B, however, the most recent activity would be within ten minutes of the current time, which would result in a status of ACTIVE. In fact, the status rule may further define the status as AT DESK since the most recent activity was so close to the current time, i.e., within ten minutes.

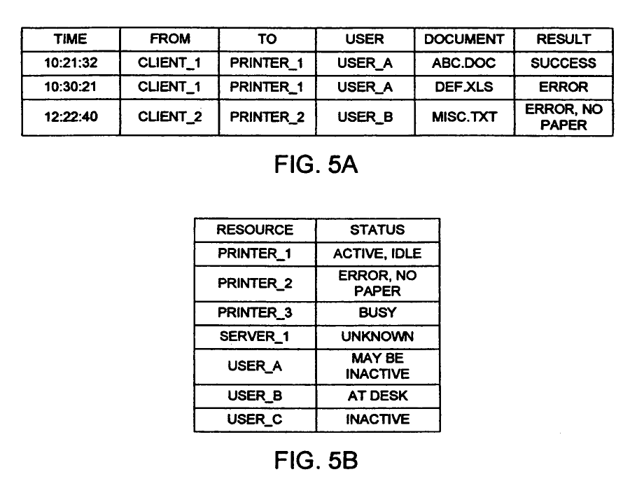

FIG. 5A is an example of an access log for a network system consistent with the present invention. This network access log shown in FIG. 5A corresponds to a conglomeration or grouping of all of the data and information from the access logs of the respective devices in the network system. The network access log can include at least as many categories as the categories included in the access logs of the individual devices in the network system. In this case, the categories include TIME, FROM, TO, USER, DOCUMENT, and RESULT. TIME, USER, DOCUMENT, and RESULT are the same as described above. FROM corresponds to the device that created the job or function to be processed, and TO corresponds to the device that receives and processes the job or function.

FIG. 5B is an example of a status table for a network system consistent with the present invention where the status rules are applied to the network system wide access log. Based on the information from the network access log shown in FIG. 5A, it is possible to determine the status of PRINTER_1, PRINTER_2, USER_A, and USER_B referenced in the examples of FIGS. 3 and 4, as well as FIG. 5A. In addition to these devices and users, for exemplary purposes, a status is shown for PRINTER_3, SERVER_1, and USER_C, although their statuses cannot be determined from the access log of FIG. 5A. Also, although not shown in the status table of FIG. 5A, the statuses of the client computers could also be determined and provided.

As shown in FIG. 5B, for PRINTER_1 and PRINTER_2, the applicable status rule defines the status as being the same as the result of the most recently performed job. For USER_A and USER_B, the applicable status rule defines the status based on the time of the most recently created or submitted job or function. For PRINTER_3, the status is found to be BUSY. This status designation may be found according to a status rule that determines if the device is performing a predetermined number of jobs in a predetermined period from the current time. As explained, the network system could collect the access logs and apply the status rules to determine the respective status of each device.

The foregoing description of a preferred embodiment of the invention has been presented for purposes of illustration and description. Of course, the various steps of detecting text, background, graphical and picture regions can be done in any order. It is not intended to be exhaustive or to limit the invention to the precise form disclosed, and modifications and variations are possible in light in the above teachings or may be acquired from practice of the invention. The embodiments were chosen and described in order to explain the principles of the invention and as practical application to enable one skilled in the art to utilize the invention in various other embodiments and with various modifications are suited to the particular use contemplated. It is intended that the scope of the invention be defined by the claims appended hereto and their equivalents.

What is claimed is:

1. A method for determining status in a network, the network having one or more devices, comprising:
accessing access log information for one or more devices on the network, the access log information including information about one or more events occurring at a device;
applying a set of rules, the set of rules having one or more rules, to the access log information; and
determining the status of the one or more devices based on the application of the set of rules to the access log information.

2. A method according to claim 1, further comprising:
determining the status of a user of at least one of the one or more devices based on the application of the set of rules to the access log information.

3. A method according claim 2, wherein the status of the user is one of active and inactive.

4. A method according to claim 2, wherein the step of determining the status of the user applies a rule which determines the status based on the most recent activity by the user according to the access log information.

5. A method according to claim 1, wherein the access log information for a device includes at least one of a job log or an access history.

6. A method according to claim 1, wherein the one or more devices include at least one of a fax machine or a multi-function peripheral.

7. A method according to claim 1, wherein at least one device maintains its own access log information, and
wherein the step of applying the set of rules includes applying the set of rules to the access log information maintained at the at least one device.

8. A method according to claim 1, wherein each of the one or more devices maintains its own access log information, and
wherein the step of applying the set of rules includes applying the set of rules to the access log information maintained at each of the one or more devices.

9. A method according to claim 1, further comprising:
maintaining a network access log containing the access log information accessed from the one or more devices, and
wherein the step of applying the set of rules includes applying the rules to the network access log.

10. A method according to claim 9, wherein the network access log is stored at at least one of a network server or a file server.

11. A method according to claim 10, wherein the network access log is stored at the network server, and
wherein the network server performs the steps of access the access log information, applying the set of rules, and determining the status.

12. A method according to claim 10, further comprising:
generating a status table having status information obtained from the application of the rules to the network access log.

13. A method according to claim 12, further comprising:
updating the status table each time a new event occurs at one of the one or more devices.

14. A method according to claim 12, further comprising:
deleting the network access log after generating the status table.

15. A method according to claim 14, further comprising:
downloading only new access log information from the one or more devices generated after the network access log has been deleted; and
updating the status table based on the new access log information.

16. A method according to claim 1, wherein the network includes a network server, and
wherein the network server performs the steps of access the access log information, applying the set of rules, and determining the status.

17. A method according to claim 1, further comprising:
determining a format of the access log information for each of the one or more devices, and
converting the format of the access log information for each of the one or more devices to a uniform format.

18. A method according to claim 17, further comprising:
converting the format of the access log information for each of the one or more devices to a uniform format.

19. A method according to claim 17, wherein the format of the access log information is determined based on device type.

20. A method according to claim 17, wherein the access log information for each of the one or more devices includes information identifying the format of the access log information.

21. A method according to claim 1, wherein the access log information includes a result of an event for at least one of the one or more devices, and
wherein the status of the least one device is determined from the result of the most recent event occurring on the at least one device.

22. A method according to claim 1, wherein the status of a device is determined from the result of the most recent event occurring on the device.

23. A method according to claim 1, wherein, in the step of determining the status of the one or more devices, the status of a device is determined to be active if an event occurred on the device within a first predetermined period from the current time, and the status of the device is unknown if no event has occurred on the device within a second predetermined period from the current time, the second predetermined period being greater than the first predetermined period.

24. A method according to claim 1, wherein, in the step of determining the status of the one or more devices, the status of a device is determined to be busy if the device has received at least a predetermined number of jobs within a predetermined period from the current time.

25. A method according to claim 1, wherein the access log information includes at least a time an event occurs at the one or more devices.

26. A method according to claim 25, wherein the access log information further includes an identification of a user causing the event and a result of the event.

27. A method according to claim 1, wherein at least one of the one or more devices is a client computer.

28. A method according to claim 1, further comprising:
notifying a user of at least one of the one or more devices of the determined status of the one or more devices.

29. A method according to claim 28, wherein the step of notifying includes generating an e-mail that includes information identifying the determined status of the one or more devices.

30. A method according to claim 1, wherein the steps of applying the status rules and determining the status of the one or more devices are performed at regular intervals.

31. A method according to claim 1, wherein the steps of applying the status rules and determining the status of the one or more devices are performed each time a new event occurs.

32. A method according to claim 1, wherein the steps of applying the status rules and determining the status of the one or more devices are performed in response to a request from a user.

33. A method according to claim 1, wherein each of the one or more devices only maintains access log information for a period corresponding to a longest period defined in the status rules.

34. A method for determining status in a network, the network having one or more devices, comprising:
accessing access log information for one or more devices on the network, the access log information including information about one or more events occurring at a device;
applying a set of rules, the set of rules having one or more rules, to the access log information; and
determining the status of a user of at least one of the one or more devices based on the application of the set of rules to the access log information.

35. A method according to claim 34, wherein, in the step of determining the status of the user, the status of the user is determined to be active if the user accessed at least one of the one or more devices within a first predetermined period from the current time, and the status of the user is inactive if the user has not accessed at least one of the one or more devices within a second predetermined period from the current time, the second predetermined period being greater than the first predetermined period.

36. A method according claim 34, wherein the status of the user is one of active and inactive.

37. A method according to claim 34, wherein the step of determining the status of the user applies a rule which determines the status based on the most recent activity by the user according to the access log information.

38. A method according to claim 1, further comprising:
determining a location of a user of at least one of the one or more devices based on the application of the set of rules to the access log information.

39. A method according to claim 38, wherein the step of determining the location of the user includes identifying a device corresponding to the most recent activity of the user in the access log information and determining a location of the identified device.

40. An apparatus configured to determine a status of one or more devices in a network having one or more devices, comprising:
a communication interface enabling communication with the one or more devices in the network;
a processor;
a memory, coupled to the processor, the memory comprising a plurality of instructions executed by the processor, the plurality of instructions configured to:
access access log information for the one or more devices on the network, the access log information including information about one or more events occurring at a device;
apply a set of rules, the set of rules having one or more rules, to the access log information; and
determine the status of the one or more devices based on the application of the set of rules to the access log information.

41. An apparatus according to claim 38, the memory further comprising an instruction configured to:
determine the status of a user of at least one of the one or more devices based on the application of the set of rules to the access log information.

42. An apparatus according claim 39, wherein the status of the user is one of active and inactive.

43. An apparatus according to claim 39, wherein the status of the user is determined to be active if the user accessed at least one of the one or more devices within a first predetermined period from the current time, and the status of the user is inactive if the user has not accessed at least one of the one or more devices within a second predetermined period from the current time, the second predetermined period being greater than the first predetermined period.

44. An apparatus according to claim 38, wherein the access log information includes a result of an event for at least one of the one or more devices, and
wherein the status of the least one device is determined from the result of the most recent event occurring on the at least one device.

45. An apparatus according to claim 38, wherein the status of a device is determined to be active if an event occurred on the device within a first predetermined period from the current time, and the status of the device is unknown if no event has occurred on the device within a second predetermined period from the current time, the second predetermined period being greater than the first predetermined period.

46. An apparatus according to claim 38, wherein the status of a device is determined to be busy if the device has received at least a predetermined number of jobs within a predetermined period from the current time.

47. A network server configured to determine a status of one or more devices in a network having one or more devices, comprising:
a communication interface enabling the network server to communicate with the one or more devices in the network;
a processor;
a memory, coupled to the processor, the memory comprising a plurality of instructions executed by the processor, the plurality of instructions configured to:
access access log information for the one or more devices on the network, the access log information including information about one or more events occurring at a device;
apply a set of rules, the set of rules having one or more rules, to the access log information; and
determine the status of the one or more devices based on the application of the set of rules to the access log information.

48. A network server according to claim 45, the memory further comprising an instruction configured to:
determine the status of a user of at least one of the one or more devices based on the application of the set of rules to the access log information.

49. A network server according claim 46, wherein the status of the user is one of active and inactive.

50. A network server according to claim 46, wherein the status of the user is determined to be active if the user accessed at least one of the one or more devices within a first predetermined period from the current time, and the status of the user is inactive if the user has not accessed at least one of the one or more devices within a second predetermined period from the current time, the second predetermined period being greater than the first predetermined period.

51. A network server according to claim 45, wherein the access log information includes a result of an event for at least one of the one or more devices, and
wherein the status of the least one device is determined from the result of the most recent event occurring on the at least one device.

52. A network server according to claim 45, wherein the status of a device is determined to be active if an event occurred on the device within a first predetermined period from the current time, and the status of the device is unknown if no event has occurred on the device within a second predetermined period from the current time, the second predetermined period being greater than the first predetermined period.

53. A network server according to claim 45, wherein the status of a device is determined to be busy if the device has received at least a predetermined number of jobs within a predetermined period from the current time.
